(19) United States
(12) Patent Application Publication
(10) Pub. No.: US 2009/0104331 A1
(43) Pub. Date: Apr. 23, 2009

(54) INULIN POWDERS AND COMPOSITIONS THEREOF

(76) Inventor: BARNARD S. SILVER, Holladay, UT (US)

Correspondence Address: BRINKS HOFER GILSON & LIONE, P.O. BOX 10395, CHICAGO, IL, 60610, US

(21) Appl. No.: 12/272,356

(22) Filed: Nov. 17, 2008

Related U.S. Application Data
(63) Continuation-in-part of application No. 11/980,037, filed on Oct. 30, 2007, now abandoned.
Application No. 11/980,037 is a continuation-in-part of application No. 11/435,649, filed on May 16, 2006, now abandoned.
(60) Provisional application No. 60/686,829, filed on May 26, 2005.

(51) Int. Cl. A23L 1/236

(52) U.S. Cl. 426/548; 426/658

(57) ABSTRACT

Inulin powders in which at least a majority of the inulin is in the form of small particles having dimension less than about 30 micrometers in their largest dimension. Inulin powders that have greater solubility than corresponding non-powdered inulin. Powdered sweeteners containing inulin with sucralose in which the sucralose has improved thermal stability and the powders have increased solubility in water. The compositions can be prepared by forming a solution of the inulin, or sucralose and inulin, in water which is then spray-dried with an atomizing nozzle, projecting a fine spray into an air stream at elevated temperatures in a chamber under a partial vacuum. Other ingredients, such as other high intensity sweeteners, natural sweeteners, non-fat dry milk, lactose, polyols, extracts, and flavorings may be included in the powder.

### RELATED APPLICATIONS

This application is a continuation-in-part of application Ser. No. 11/980,037, filed Oct. 30, 2007, which is a continuation-in-part of application Ser. No. 11/435,649, filed May 16, 2006, the latter of which claims priority to U.S. Provisional Patent Application Ser. No. 60/686,829, filed May 26, 2005.

### FIELD OF THE INVENTION

The present invention relates to inulin powders and compositions thereof, especially sweetener powder compositions.

### BACKGROUND

Inulin has been available in various granular forms and was suggested as a bulking agent for many years, but with only little commercial success. One problem with granular inulin as a bulking agent is its limited solubility in water at ambient temperatures.

Sucralose is a water soluble, non-caloric sweetener about 600 times sweeter than sugar. Sucralose is known as an “intense sweetener.” Because it is a high intensity sweetener, sucralose presently is most often sold mixed with bulking agents, such as maltodextrin and/or dextrose (glucose).

While many people seeking diet control, for example, those with diabetes, are interested in sucralose as a sweetener because it is non-caloric, yet sucralose is most often sold with dextrose (glucose) and/or maltodextrin as bulking agents, each of which has a high glycemic index (the glycemic index of dextrose is 100, and the glycemic index of maltodextrin is reported to be 105, or higher). Products containing dextrose and/or maltodextrin, therefore, are unattractive to those seeking a low glycemic diet.

If sucralose is used without any bulking agent, another problem may occur. Sucralose alone, if heated to elevated temperatures, changes from white to a deep chocolate brown color. The change in color indicates decomposition of the sucralose molecule. The change in color is accompanied by reductions in the sweetness.

Yet another problem arises if sucralose is mechanically dry-mixed with bulking agents. Due to the high intensity sweetness of sucralose, it is difficult to disperse sucralose throughout any bulking agent uniformly by dry mixing. As a result of mechanical dry-mixing, parts of the mixture may be sweeter than others.

Sucralose is reported to be very stable at high temperatures in foods and beverages in which it is dispersed in relatively low concentrations. However, pure, dry, crystalline sucralose is reported to be rather less stable at high temperatures.

### SUMMARY

It is an objective of the present invention to provide inulin compositions in the form of a soft, fluffy powder.

It is a further objective of the invention to create a synergistic taste by combining inulin with extracts and/or flavor ingredients in a powder.

It is another objective of the invention to provide forms of inulin that dissolve quickly, or more quickly, in water, or the saliva in the mouth than the non-powder forms of inulin, and that have greater solubility in water or water base liquids, than the mother inulin from which they are produced. It is a further objective of the invention to produce a form of inulin which is characterized by especially rapid solubility in water at ambient temperatures.

It is still another objective of the present invention to provide a powder form of inulin composition that is low in hygroscopicity.

It is another objective of the present invention to provide a sweetener composition that has nutritive benefits, yet has low caloric values, and a glycemic index of zero, or near zero.

It is yet another objective of the invention to provide a sweetener composition containing sucralose in which the sucralose is protected from decomposition at elevated temperatures.

It is still yet another objective of the present invention to provide a sweetener composition containing inulin powder in a form that upon ingestion benefits human health.

These and other advantages and benefits of the invention will be apparent from the following detailed description and appended claims.

### DETAILED DESCRIPTION OF THE INVENTION

The following definitions are to be understood throughout this description and in the appended claims: A “foodstuff” is a substance that can be used or prepared for use as a food. A “carbohydrate” as defined in Organic chemistry, Second Edition by William H. Brown and Christopher S. Foote (Saunders, 1998) is a polyhydroxyaldehyde, polyhydroxyketone, or substance that gives these compounds upon hydrolysis. A “monosaccharide” is a carbohydrate that cannot be hydrolyzed to a simpler carbohydrate. A “disaccharide” is a carbohydrate containing two monosaccharide units joined by a glycoside bond. A “trisaccharide” is a carbohydrate containing three monosaccharide units joined by a glycoside bond. A “polysaccharide” as defined in Webster's Ninth New Collegiate Dictionary (Merriam-Webster, 1988), is a carbohydrate that can be decomposed by hydrolysis into two or more molecules of monosaccharides (thus, this definition subsumes the definitions of disaccharide and trisaccharide). An “extract” refers to food additives, such as grape seed extract. A “polyol” is the product obtained from the reduction of a carbohydrate whereby the carbonyl group (C═O) of a monosaccharide unit is replaced with a CHOH moiety. “Inulin” refers to a mixture of polysaccharides having various molecular weights or degrees of polymerization; in general, inulin consists of fructose units with β (2-1) bonds terminating in a glucose unit. “Raw” inulin refers to inulin containing low molecular-weight and high molecular-weight polysaccharides. “Native” inulin refers to inulin containing substantially the same polysaccharides as found in chicory with or without the monosaccharides and/or disaccharides. “Inulin” refers to all the fractions of inulin whether high or low molecular weights or both. “Intense sweeteners” is a term well-known in the art which refers to compounds that are significantly sweeter than sucrose. “Natural sweeteners” refers to sucrose, fructose, dextrose, maltose, and the like.

The invention relates to a unique powder form of inulin that has several unexpected properties as compared to native inulin. The powdered inulin of the invention dissolves in water or water base liquids more quickly at ambient temperatures than the granular forms of inulin. In a most preferred form, a soft fluffy powder of inulin dissolves quickly in water at ambient temperatures: for example, said powder dissolved in water in less than about 5 seconds without stirring.

The inulin powder of the invention comprises a majority of small particles of inulin of which the largest dimension of said small particles is about 30 micrometers or less. The particles may be substantially spherical or odd shape or mixtures of both. An especially preferred embodiment of the invention has particles of less than 20 micrometers or less and is characterized by especially rapid solubilization in water at ambient temperatures or below.

The inulin powder is made by dissolving or dispersing granular inulin in water, atomizing the water solution or dispersion into a fine spray through a spray nozzle, and projecting the spray in a hot air stream within a chamber maintained under a partial vacuum. The water solution or dispersion of inulin is projected through one or more spray nozzles under high pressures.

The hot air stream in the spray-drier dries the inulin under a partial vacuum to a powder which is collected. Examples of suitable spray-driers are the Niro two chamber spray-drier and the C.E. Rogers spray-drier. Laboratory units, such as the Armfield Plant Dryer SD 04, also are suitable.

This invention further relates to sweetener compositions containing high intensity sweeteners together with inulin powder, for example, sucralose (4,1′,6′-trichloro-4,1′,6′-trideoxygalactosucrose) intimately mixed with inulin as a bulking agent. The inulin powder and the inulin sweetener of the invention, among other features, are characterized by a warm sensation in the mouth when dissolved in saliva. Unique tastes and mouth feel are imparted to the combination of the inulin spray-dried powder and to the combinations of the inulin and sucralose in the spray-dried powders.

The inulin powders and the inulin sweetener compositions have a lower hygroscopicity than powdered sucrose. Commercial or retail forms of powdered sucrose usually require adulterants, such as corn starch, to reduce hygroscopicity, an expedient unnecessary for the powdered inulin described herein.

The inulin powder of the present invention is characterized by substantially preserving the intense sweetener against degradation when intimately combined with inulin during spray-drying operation.

For example, it has been indicated (U.S. Pat. No. 4,927,646) that a simple dry mixture of crystalline sucralose and maltodextrin containing 33.8% sucralose by weight showed some loss of sucralose after 25 days storage at 113° F. Also, it has been reported that pure, dry crystalline sucralose itself discolors after about one week at 113° F. with measurable losses of sucralose after about three to four weeks.

Sucralose alone is difficult to spray-dry. However, aqueous co-solutions of inulin and sucralose can be spray-dried satisfactorily, as illustrated herein.

The inulin employed may be either the raw, or native inulin extracted from plants, such as the inulin extracted from chicory, Jerusalem artichokes, jicama, agave and the like, preferably chicory, characterized by polysaccharides with chain length from three to about 60, or, inulin processed into shorter chain lengths as disclosed in U.S. Pat. No. 6,569,488. Thus, the inulin currently available for processing include high molecular weight inulin, for example, inulin having at least 75% by weight inulin with molecular weights above 2288; low molecular weight, for example, inulin having at least 75% by weight inulin with molecular weight of 2288, and below; and mixtures of high and low molecular weights. In any case, both high and low molecular weight inulin are usually available in granular form.

Upon dissolving sucralose together with inulin in water, and spray-drying according to the present invention, a noncrystalline form of a powder sweetener is formed in which sucralose is dispersed evenly throughout the powder. The powder is soft and fluffy containing substantially small particles in which at least a majority of said particles have as their largest dimension less than about 30 micrometers and preferably less than about 20 micrometers in their largest dimension.

The bulk density of the final spray-dried powder is preferably 0.299 or less, most preferably less than about 0.26, desirably about 0.24 and less, and most desirably about 0.22 and less. Lower bulk densities are characterized by a softer, fluffier powder.

The sweetener powders of the present invention that may optionally contain other water-dispersible or soluble ingredients, such as additional high intensity sweeteners, natural sweeteners, non-fat dry milk, lactose, polyols, extracts, and/or flavorings.

The intense sweeteners mixed with the inulin to make powder sweetener compositions may be sucralose, aspartame, stevia, acesulfame potassium, saccharin, neotane. Sucralose is preferred.

The dry weight ratio of inulin to sucralose in the powder sweeteners may be about 1200:1, or 900:1 or 700:1, or 500:1, or 300:1, or 200:1, or outside these ratios, depending upon the degree of sweetness desired. For most uses, a ratio by dry weight of inulin to sucralose will be within the range from about 900:1 to 1:1, preferably from 700:1 to 1:1, and desirably from about 500:1 to 1:1.

In particular, sweetener concentrates comprising synergistic combinations of inulin with sucralose, or other high intensity sweeteners such as saccharin, acesulfame-K, aspartame, neotane, stevia and polyols may be used.

In making the inulin powder or the sweetener powders of the present invention, the pressure of the (Pump psi) line supplying the solution entering the spray nozzle preferably should be at least above about 1200, most preferably above about 1500, and desirably above about 1800 pounds per square inch (psi). The hot air into which the solution is sprayed should be at least about 300° F., preferably at least 325° F. and the outlet temperature at least about 180° F. The partial vacuum in the spray chamber should be at least about −0.25 inches of water. A double spray nozzle (Sprayer Systems Corporation's No. 50/21) for atomizing the spray is preferable.

The following definitions are to be understood in connection with the process.

The “Pump psi” is the pressure in pounds per square inch in the line that supplies the water containing the inulin or inulin and sucralose (or other intense sweetener) to the spray nozzle. The “Inlet Temp.” is the temperature in the area of the hot air stream into which the spray from the spray nozzle is projected. The “Outlet Temp.” is the temperature of the gases exiting the chamber or the entrance to the bag house. The “Dryer Pressure” is the vacuum of the chamber, measured in inches of water.

The invention may be illustrated further by the following non-limiting examples listed below. Examples 1-6 show that spray-drying sucralose with inulin protects the sweetness of sucralose at elevated temperatures.

### EXAMPLE 1

200 grams of inulin and 2 grams of sucralose were mixed in 1 liter of distilled water at room temperature. This 20.2% mixture of solids to water was spray-dried in a two-stage Niro spray-drier having an inlet temperature of 329° F. and an average outlet temperature of 187° F. The product was in the form of a powder having light fluffy clumps which had a bulk density of 0.24 grams per cubic centimeter. Microscopic examination revealed the powder clumps comprised substantially of spherically shaped particles having diameters less than 30 micrometers.

The too sweet white fluffy clumps were placed in a CENCO oven at 174° F., held for 23 minutes with the oven temperature being raised continuously to 189° F. The spray-dried sample was observed to retain its white color and fluffy clump form.

The sample was again heated from 171° F. to 183° F. for 8 minutes. The sample was reinspected and observations made that the white color was still present as was the fluffy clump form.

The sample was held for a third period of time at 8 minutes at 180° F. The sample was again inspected and observed to have the same white color as originally and in the fluffy clump form.

The sample was then kept at laboratory heater temperature of 64° F. for 11 days and final inspection established that the white color was maintained along with its too sweet taste.

### EXAMPLE 2

150 grams of inulin and 15 grams of sucralose were mixed in 0.5 liters of distilled water at room temperature. This 33% mixture was spray-dried in a two stage Niro spray-drier having an inlet temperature of 329° F. and an average outlet temperature of 194° F. The produce was in the form of light fluffy clumps that had a bulk density of 0.23 grams per cubic centimeter. Microscopic examination revealed the powder clumps comprised of substantially spherically shaped particles having diameters less than 30 micrometers.

The sweet white fluffy clumps were placed in a CENCO oven at 174° F., held for 23 minutes with the oven temperature being raised continuously to 189° F. The spray-dried sample was observed to retain its white color.

The sample was again heated from 171° F. to 183° F. for 8 minutes. The spray-dried sample was observed to retain its white color and fluffy clump form.

The sample was again heated from 171° F. to 183° F. for 8 minutes. The sample was reinspected and observations made that the white color was still present as was the fluffy clump form.

The sample was held for a fourth period of time at 8 minutes at 180° F. The sample was again inspected and observed to have the same white color as originally and the fluffy clump form.

The sample was then kept at laboratory heater temperature of 64° F. for 11 days and final inspection established that the white color was maintained along with its far too sweet taste.

### EXAMPLE 3

To the one half liter of the liquid mixture remaining from Example 1 was added 79.996 grams of inulin at room temperature. This 33% mixture was spray-dried in a two-stage Niro spray-drier at an inlet temperature of 329° F. and an average outlet temperature of 180° F. The product was in the form of a powder of light fluffy clumps which had a bulk density of 0.23 grams per cubic centimeter. Microscopic examination revealed the powder clumps comprised substantially of spherically shaped particles having diameters less than 30 micrometers.

The overly sweet white fluffy clumps were placed in a CENCO oven at 174° F., held for 23 minutes with the oven temperature being raised continuously to 189° F. The spray-dried sample was observed to retain its white color and fluffy clump form.

The sample was again heated from 171° F. to 183° F. for 8 minutes. The sample was reinspected and observations made that the white color was still present as was the fluffy clump form.

The sample was held for a third period of time at 8 minutes at 180° F. The sample was again inspected and observed to have the same white color as originally and the fluffy clump form.

The sample was then removed from the laboratory heater and kept in a room that varied in temperature and humidity for 11 days and final inspection established that the white color was maintained along with its overly sweet taste.

### EXAMPLE 4

165 grams of inulin and 0.275 grams of sucralose were mixed in 500 milliliters of distilled water at room temperature. This 33% mixture was spray-dried in a two-stage Niro spray-drier having an inlet temperature of 329° F. and an average outlet temperature of 185° F. The product was in the form of a powder having light fluffy clumps and a bulk density of 0.27 grams per cubic centimeter. Microscopic examination revealed the powder clumps comprised substantially of spherically shaped particles having diameters less than 30 micrometers.

The sweet (equal to the sweetness of sucrose to the experimenter's taste) white fluffy clumps were put in a CENCO oven at 174° F., held for 23 minutes with the oven temperature being raised continuously to 189° F. The spray-dried sample was observed to retain its white color and fluffy clump form.

The sample was again heated from 171° F. to 183° F. for 8 minutes. The sample was reinspected and observations made that the white color was still present as was the fluffy clump form.

The sample was held for a third period of time at 8 minutes at 180° F. The sample was again inspected and observed to have the same white color as originally and the fluffy clump form.

The sample was then kept at laboratory heater temperature of 64° F. for 11 days and final inspection established that the white color was maintained along with its sweet taste.

### EXAMPLE 5

44.4 grams of inulin and 22.2 grams of sucralose were mixed in 200 milliliters of distilled water at room temperature. This 33% mixture was spray-dried at an inlet temperature of 329° F. and an average outlet temperature of 183° F. The product was in the form of a powder comprising light fluffy clumps and a bulk density of 0.25 grams per cubic centimeter. Microscopic examination revealed the powder clumps comprised substantially of spherically shaped particles having diameters less than 30 micrometers.

The sweet white fluffy clumps were placed in a CENCO oven at 174° F., held for 23 minutes with the oven temperature being raised continuously to 189° F. The spray-dried sample was observed to retain its white color and fluffy clump form.

The sample was again heated from 171° F. to 183° F. for 8 minutes. The sample was reinspected and observations made that the white color was still present as was the fluffy clump form.

The sample was held for a third period of time at 8 minutes at 180° F. The sample was again inspected and observed to have the same white color as originally and the fluffy clump form.

The sample was then kept at laboratory heater temperature of 64° F. for 11 days and final inspection established that the white color was maintained along with its much too sweet taste.

### EXAMPLE 6

Sucralose, as purchased, was weighed and found to have a bulk density of 0.7 (grams per cubic centimeter).

The intolerably sweet white powder sucralose was placed in a CENCO oven at 174° F., held for 23 minutes with the oven temperature being raised continuously to 189° F. Upon inspection, the sucralose on the heating tray for the bottom one-half of the little pyramid was an almost milk-chocolate brown color and the white powder had turned into small brown granules. The top one-half was still the white powder.

The sample above was again heated from 171° F. to 183° F. for 8 minutes. Inspection of the sucralose on the heating tray for the bottom 0.9 of the little pyramid was a milk-chocolate brown color small granules and the top 0.1 was white powder.

The sample above was held for a third period of time at 8 minutes at 180° F. The sample was again inspected and observed to be between a milk-chocolate and dark-chocolate brown color much smaller granule pyramid.

The sample above was then kept at laboratory heater temperature of 64° F. for 11 days and final inspection established that the color between a milk-chocolate and dark-chocolate brown was maintained. The granular form was also maintained. Most importantly, the intolerably sweet taste was gone. The after-heating sucralose was no sweeter than sucrose, the conventional table-top sugar.

As seen by analyzing Examples 1-5, a spray-dried non-crystalline product containing inulin retains its sweetness (See Examples 1-5). However, sucralose alone (See Example 6) loses its sweetness at elevated temperatures.

While not wishing to be bound by any theory, the inulin seems to protect the sucralose against degradation, for example, to protect against sweetness degradation, over a wide volume ratio of sucralose to inulin at elevated temperatures.

Examples 7-11 below further illustrate the powder compositions and processes of the invention.

### EXAMPLE 7

252 pounds of water was mixed with 44.8 pounds of inulin and 67.74 grams of sucralose (300:1 ratio inulin:sucralose) and were spray-dried under the conditions below: 28.2 pounds of a soft, fluffy white powder was made. The powder comprised a majority of spherically shaped particles, a majority of which were less than 30 micrometers in diameter.

| | | | | DRYER | |
|---|---|---|---|---|---|
| | INLET | OUTLET | | PRESSURE | PRODUCT |
| | TEMP. | TEMP. | PUMP | INCHES OF | BULK |
| TIME | ° F. | ° F. | PSI | H₂0 | DENSITY |
| 1011 | Start | | | | |
| 1012 | 502 | 236 | 500 | | |
| 1013 | 565 | 234 | | | |
| 1014 | 575 | 235 | 500 | −0.25 | |
| 1015 | 604 | 237 | 510 | −0.25 | |
| 1017 | 610 | 238 | 530 | −0.25 | |
| 1018 | 613 | 249 | 750 | −0.25 | |
| 1022 | 616 | 239 | 950 | −0.25 | |
| 1023 | 621 | 239 | 1075 | −0.25 | |
| 1027 | 601 | 238 | 1000 | −0.25 | |
| 1028 | 593 | 237 | 1000 | −0.25 | |
| 1030 | 588 | 236 | 1100 | −0.25 | 0.40 |
| 1034 | 589 | 235 | 1100 | −0.25 | |
| 1041 | 587 | 236 | 1500 | −0.25 | |
| 1046 | 585 | 222 | 2050 | −0.25 | |
| 1050 | 580 | 217 | 2100 | −0.25 | |
| 1055 | 554 | 217 | 1600 | −0.4 | |
| 1100 | 527 | 227 | 1525 | | 0.22 |
| 1114 | 527 | 232 | 1525 | −0.37 | |
| 1126 | 529 | 236 | 1600 | −0.37 | 0.22 |
| 1131 | 531 | 236 | 550 | −0.37 | |
| 1136 | 530 | 239 | 1475 | −0.37 | |
| 1146 | 508 | 235 | 1500 | −0.37 | 0.22 |
| 1153 | 512 | 233 | 1500 | −0.37 | |
| 1205 | 495 | 227 | 1600 | −0.37 | 0.22 |
| 1214 | 511 | 229 | 1600 | −0.37 | |
| 1224 | 512 | 229 | 1650 | −0.37 | |
| 1228 | 513 | 228 | 1650 | −0.37 | |
| 1231 | 503 | 226 | 1500 | −0.37 | |
| 1232 | Shut Down | | | | |

### EXAMPLE 8

134.26 grams of sucralose were mixed with 88.8 pounds of inulin for a 300:1 inulin to sucralose ratio and 220.4 pounds of water and spray-dried on a C.E. Rogers Spray Dryer under conditions set forth below. The product was 77.8 pounds of a soft, fluffy powder. The powder comprised a majority of spherically shaped particles, a majority of which had diameters less than 30 micrometers.

| | | | | DRYER | |
|---|---|---|---|---|---|
| | INLET | OUTLET | | PRESSURE | PRODUCT |
| | TEMP. | TEMP. | PUMP | INCHES OF | BULK |
| TIME | ° F. | ° F. | PSI | H₂0 | DENSITY |
| 1407 | Start | | | | |
| 1407 | 487 | 220 | 1000 | −0.25 | |
| 1412 | 533 | 215 | 1200 | −0.25 | |
| 1414 | 536 | 214 | | −0.25 | |
| 1415 | 539 | 213 | 1150 | −0.25 | |
| 1419 | 547 | 210 | 1400 | −0.25 | 0.22 |
| 1425 | 541 | 210 | 1400 | −0.25 | |
| 1430 | 540 | 213 | 1600 | −0.25 | |
| 1435 | 527 | 213 | 1600 | −0.25 | |
| 1436 | 502 | | | −0.25 | |
| 1441 | 569 | 211 | | −0.20 | 0.22 |
| 1448 | 580 | 213 | 1550 | −0.20 | |
| 1452 | 508 | 213 | 1600 | −0.3 | |
| 1455 | 468 | 209 | 1600 | −0.33 | |
| 1459 | 454 | 207 | 1600 | −0.33 | |
| 1502 | 430 | 203 | 1475 | −0.33 | 0.27 |
| 1512 | 443 | 203 | 1500 | −0.33 | |
| 1514 | 445 | 201 | 1650 | −0.33 | 0.26 |
| 1526 | 445 | 206 | 1600 | −0.33 | 0.24 |
| 1530 | 433 | 201 | 1550 | −0.33 | |
| 1535 | 438 | 202 | 1500 | −0.33 | |
| 1536 | 439 | 202 | 1500 | −0.33 | |
| 1541 | 446 | 200 | 1650 | −0.33 | 0.29 |
| 1556 | 428 | 201 | 1600 | −0.34 | |
| 1605 | 446 | 201 | 1600 | −0.34 | 0.27 |
| 1613 | 437 | 203 | 1500 | −0.34 | |
| 1625 | 434 | 199 | 1650 | −0.34 | 0.28 |
| 1632 | 432 | 199 | 1600 | −0.34 | |
| 1641 | 431 | 201 | 1650 | −0.34 | |
| 1643 | 440 | 203 | 0 | −0.34 | |
| Stop at 1643 | | | | | |
| Shut Down | | | | | |

### EXAMPLE 9

264.6 pounds of low and high molecular weight inulin were mixed with 1058 pounds of water and spray-dried in a Niro spray-drier with twin cyclones. The product from the spray drier was a white soft, fluffy powder that weighed 208.9 pounds. The conditions for spray-drying are below. The powder product comprised a majority of spherically shaped particles, a majority of which had diameters less than 30 micrometers.

| | | | | DRYER | |
|---|---|---|---|---|---|
| | INLET | OUTLET | | PRESSURE | PRODUCT |
| | TEMP. | TEMP. | PUMP | INCHES OF | BULK |
| TIME | ° F. | ° F. | PSI | H₂0 | DENSITY |
| 1220 | Start | | | | |
| 1225 | 343 | 230 | 2000 | −0.30 | |
| 1241 | 342 | 231 | 2000 | −0.30 | |
| 1245 | 346 | 232 | 2000 | −0.30 | 0.24 |
| 1301 | 348.8 | 228 | 2000 | −0.30 | |
| 1309 | 346.1 | 231 | 2000 | −0.30 | 0.24 |
| 1319 | 344.4 | 230 | 2000 | −0.30 | |
| 1330 | 345.5 | 230 | 2000 | −0.30 | 0.23 |
| 1336 | 347.3 | 230 | 2000 | −0.30 | |
| 1340 | 347 | 230 | 2000 | −0.30 | 0.24 |
| 1340 | Stop | | | | |

### EXAMPLE 10

265 pounds of low molecular weight inulin was mixed with 397.5 pounds of water and sprayed in a Niro spray-drier with twin 72 inch diameter cyclones under the following conditions. 198.2 pounds of a soft, fluffy white powder were produced. The powder comprised a majority of spherically shaped particles, a majority of which have diameters less than 30 micrometers.

| | | | | DRYER | |
|---|---|---|---|---|---|
| | INLET | OUTLET | | PRESSURE | PRODUCT |
| | TEMP. | TEMP. | PUMP | INCHES OF | BULK |
| TIME | ° F. | ° F. | PSI | H₂0 | DENSITY |
| 1426 | Start | | | | |
| 1433 | 425 | 232 | 2000 | −0.30 | |
| 1442 | 420 | 231 | 2000 | −0.30 | |
| 1454 | 404.8 | 232 | 2000 | −0.30 | |
| 1500 | 399.8 | 231 | 2000 | −0.30 | |
| 1505 | 391 | 229 | 2000 | −0.30 | 0.23 |
| 1517 | 407.3 | 233 | 2000 | −0.27 | |
| 1525 | 390.1 | 229 | 2000 | −0.29 | 0.24 |
| 1536 | 401.3 | 232 | 2000 | −0.30 | |
| 1547 | 400.4 | 231 | 2000 | −0.30 | 0.25 |
| 1558 | 400.3 | 230 | 2000 | −0.30 | 0.24 |
| 1609 | 367 | 240 | 2000 | −0.30 | |

### EXAMPLE 11

1587.3 pounds of low molecular weight inulin were mixed with 5.3 pounds of sucralose and 2,381 pounds of water and spray-dried in a Niro twin cyclone spray-drier under the following conditions. 1,208.2 pounds of soft, fluffy white powder were produced. The powder comprised a majority of spherically shaped particles, a majority of which had diameters less than 20 micrometers.

| | | | | DRYER | |
|---|---|---|---|---|---|
| | INLET | OUTLET | | PRESSURE | PRODUCT |
| | TEMP. | TEMP. | PUMP | INCHES OF | BULK |
| TIME | ° F. | ° F. | PSI | H₂0 | DENSITY |
| 1655 | Start | | | | |
| 1705 | 373.3 | 231 | 2120 | −0.30 | |
| 1715 | | | | | 0.29 |
| 1730 | 368.8 | 231 | 1950 | −0.30 | |
| 1740 | | | | | 0.24 |
| 1745 | 411.3 | 233 | 2000 | −0.30 | |
| 1800 | 415.6 | 231 | 2005 | −0.30 | |
| 1815 | 415.8 | 232 | 2010 | −0.30 | 0.23 |
| 1845 | 420.5 | 232 | | −0.27 | 0.26 |
| 1848 | 424.4 | 230 | 2600 | −0.29 | |
| 1910 | 437.8 | 233 | 2600 | −0.30 | |
| 1915 | | | | | 0.25 |
| 1935 | Off | | | | |
| | Product | | | | |

### EXAMPLE 12

705.5 pounds of low and high molecular weight inulin were mixed with 2.35 pounds of sucralose and 2,116.5 pounds of water and spray-dried in a Niro spray-drier with twin 72 inch cyclones under a partial vacuum. The conditions are set forth below. The product was 434.4 pounds of a soft, fluffy powder. The powder comprised at least a major amount of particles of which at least a majority of which were spherically shaped and most of which had diameters less than 30 micrometers.

| | | | | DRYER | | |
|---|---|---|---|---|---|---|
| | INLET | OUTLET | | PRESSURE | | PRODUCT |
| | TEMP. | TEMP. | PUMP | INCHES OF | | BULK |
| TIME | ° F. | ° F. | PSI | H₂0 | COMMENTS | DENSITY |
| 2045 | Start | | | | 3 spray | |
| | | | | | nozzles on | |
| | | | | | line | |
| 2103 | 431.1 | 226 | 2400 | −0.30 | | |
| 2110 | | | | | | 0.17 |
| 2115 | 448.9 | 231 | 2600 | −0.25 | | |
| 2130 | 456 | 231 | 2700 | −0.20 | | 0.18 |
| 2145 | 446.2 | 232 | 2550 | −0.20 | | |
| 2155 | | | | | | 0.18 |
| 2200 | 441.4 | 229 | 2750 | −0.20 | | |
| 2215 | 451.3 | 231 | 2650 | −0.20 | | |
| 2220 | End of product feed | | | | | 0.17 |
| 2230 | 443.3 | 230 | 2500 | −0.20 | | |
| 2238 | 306.3 | 235 | | −0.25 | | |
| 2251 | 391.3 | 231 | | | | |

### EXAMPLE 13

120 grams of high molecular-weight inulin were mixed with 0.32 grams of sucralose and 800.05 grams of water and spray-dried in an Armfield Lab Plant Spray Dryer SD-04. A soft, fluffy white powder was produced. Microscopic studies revealed that the powder contained fine particles, a majority of which were spherically shaped and most of which had diameters less than 30 micrometers.

| | | | | DRYER | | |
|---|---|---|---|---|---|---|
| | INLET | OUTLET | | PRESSURE | | PRODUCT |
| | TEMP. | TEMP. | PUMP | INCHES OF | | BULK |
| TIME | ° F. | ° F. | PSI | H₂0 | COMMENTS | DENSITY |
| 0110 | Start | | | | 1 spray | |
| 0110 | 374 | 250 | 29 | −7 | nozzle | |
| 0115 | 374 | 255 | 29 | −6 | | |
| 0124 | 374 | 253 | 29 | −6 | | |
| 0134 | 374 | 244 | 29 | −6 | | |
| 0143 | 374 | 248 | 29 | −5 | | |
| 0151 | 374 | 248 | 29 | −4 | | |
| 0200 | 374 | 244 | 29 | −4 | | |
| 0205 | 374 | 235 | 29 | −4 | | |
| 0213 | 374 | 264 | 30 | −3 | | |
| 0219 | 374 | 262 | 30 | −3 | | |
| 0224 | 374 | 225 | 32 | −2 | | |
| 0230 | 374 | 217 | 32 | −5 | | |
| 0236 | 374 | 219 | 31 | −7 | | |
| 0240 | 374 | 216 | 30 | −8 | | |
| 0244 | 374 | 221 | 29 | −9 | | |
| 0248 | 374 | 223 | 29 | −9 | | |
| 0253 | 374 | 226 | 29 | −9 | | 0.22 |

### Taste and Mouth Feel

The inulin powder and the sweetener powder compositions are characterized by a surprisingly warm taste sensation in the mouth. The polyols and lactose have negative heats of solution when added to water, thus, they are endothermic, but the powder products of the present invention, like the mother inulin, have a positive heat of solution in water, and are exothermic. For example, adding 2.5 grams of inulin, whether the mother inulin, or the spray-dried inulin, or spray-dried inulin with sucralose, to 50 grams of distilled water at ambient temperatures (about 77° F.) raised the temperature of the solution by about one degree Fahrenheit (1° F.). The exothermic action is noticeable in the mouth when the inulin powders and/or sweetener powders of the invention are placed therein and tasted. The reason for the heat of solution of the present sweetener invention is unexplainable, but seems to be contributed by the inulin powders. The powdered forms of spray-dried inulin seem to heighten the sensation of sweetness. The inulin powder and/or the inulin sweetener powder have a unique taste and sweetness as compared to their mother inulin. These phenomena contribute a unique taste and/or sweetness to the spray-dried powders of the invention. The inulin spray-dried powders and inulin-sucralose spray-dried powders act synergistically with the saliva in the mouth to produce unique pleasant tastes.

### EXAMPLE 14

Granular inulin having a low molecular weight was compared to inulin powder for taste and mouth feel with the following results.

The low molecular weight mother granular inulin felt grainy, then sticky on teeth, tongue, and roof of mouth; tasted dusty and then a slightly sweet taste. There was no warm sensation. The low molecular weight powdered inulin felt fluffy and warm. It quickly dissolved in the mouth with an immediate sweet warm taste, followed by a slight stickiness on tongue. The sweetness remained. The low molecular weight inulin powder with sucralose felt fluffy and immediately warm with a strong sweetness that lasted.

Granular inulin having low and high molecular weight was compared to similar low and high molecular weight spray-dried inulin powder in the mouth. The low and high molecular mother granular inulin felt chunky, granular, and sticky in the mouth, then came faint sweetness. The low and high molecular weight spray-dried powdered inulin felt warm, dissolved quickly, and tasted moderately sweet. The low and high molecular weight spray-dried powdered inulin with sucralose also felt fluffy and warm and dissolved in the mouth with a strong, full-bodied sweetness that lasted for a substantial time.

The high molecular weight granular inulin in the mouth felt chunky, did not dissolve, and only by chewing were the chunks broken up; the small particles remained stuck to the teeth. There was no sweetness. By comparison, a high molecular weight spray-dried powdered inulin with stevia began to dissolve rapidly in the mouth, although some particles stuck to the teeth for about one minute and then dissolved. Strong warm sweetness came to begin with, mild sweetness followed.

Both warmth and sweetness occur in the spray-dried powders of the invention.

### Solubility

The inulin powders of the invention also have greater solubility compared to the mother inulin from which they were made, as shown by the following.

### EXAMPLE 15

In EXAMPLE 10, 0.4 grams of low molecular weight inulin, before spray drying, were put into a test tube with 8 grams distilled water at 72° F. [Sample 10B]. After the first gentle rocking, small suspended particles were visible. After continuous gentle rocking in a test tube for two minutes, this product showed still the same number of small suspended particles. After an additional half minute of rocking, the particles were partly dissolved, and after an additional half minute of rocking the particles were completely dissolved.

In EXAMPLE 10, after spray drying, in contrast to Sample 10B before spray drying, 0.4 grams of low molecular weight inulin powder were put in 8 grams of distilled water in a test tube [Sample 10A]. This powder went into solution immediately upon the very first rocking of the test tube.

### EXAMPLE 16

In EXAMPLE 9, 0.314 grams of a mixture of low and high molecular weight inulin, before spray drying, were put into a test tube with 7.85 g distilled water at 70° F. [Sample 9B]. After the first gentle rocking, a barely discernible clump of inulin was at the bottom of an opaque solution in the test tube. After 3 minutes of gentle rocking of the test tube, the liquid became clear and suspended particles were visible with a mass of inulin still clumped in the tube. After 4.5 minutes of additional gentle rocking of the test tube the mass was gone and fairly dense big and small particles were in the test tube. Thereafter, left sitting for an additional 13.5 minutes a mass was at the bottom of the test tube. Upon rocking three big particles and many small particles were visible in the test tube. After 48 hours of sitting, the bottom of the test tube was covered with particles. Upon gentle rocking the three large particles were still present with gradations of particles down to very small particles.

### EXAMPLE 17

In EXAMPLE 9, after spray drying, in contrast to Sample 9B before spray drying, 0.313 grams of a mixture of low and high molecular weight inulin were put into a test tube with 7.837 grams distilled water at 70° F. [Sample 9A]. After the first gentle rocking, many white flakes of inulin were observed in a clear solution in the test tube. After 1 minute of gentle rocking of the test tube there were some flakes and some small fines. After 1 minutes of additional gentle rocking of the test tube the small fines were gone and two flakes remained in the test tube. Thereafter, left sitting for an additional 3 minutes a small mass of white was at the bottom of the test tube. Upon rocking one big flake, and seven small flakes were visible in the test tube. After 48 hours of sitting, the test tube had a few very small particles in the bottom. Upon gentle rocking the particles decreased to about one third the number of particles in Sample 10B. There were no large particles present.

### EXAMPLE 18

In EXAMPLE 13, 0.075 grams of high molecular weight inulin, before spray drying, were put into a test tube with 7.5 g distilled water at 70° F. [Sample 13B]. After the first gentle rocking, a foggy solution was in the test tube. After 3 minutes of gentle rocking of the test tube the liquid was still opaque. Leaving the test tube to sit 30 minutes observations were again made. One-half the bottom of the test tube was covered. Upon gently rocking one very big particle about one quarter the size of the bottom of the test tube, one half that size, and many small particles were visible in the test tube. After 48 hours of sitting the bottom of the test tube was one twelfth covered with particles one being one twelfth the size of the bottom and one particle being one twenty-forth the size of the bottom. The solution continued to be foggy but not completely opaque as at first.

### EXAMPLE 19

In EXAMPLE 13, after spray drying, in contrast to Sample 13B before spray drying, 0.074 grams of high molecular weight inulin were put into a test tube with 7.422 grams of distilled water at 70° F. [Sample 13A]. After the first gentle rocking, the solution was clear immediately. One medium sized flake 1/24^{th} the size of the bottom of the test tube and thirty small white flakes of inulin were observed in a clear solution in the test tube. After 1 minute of gentle rocking of the test tube the same flakes remained in the test tube. Thereafter, left sitting for an additional 30 minutes a small mass of white flakes remained that covered ⅛th the bottom of the test tube. After 48 hours of sitting the solution in the test tube remained clear and at the bottom remained one flake 1/24^{th} size of the bottom of the test tube, one about 1/48^{th} size, and the rest small particles. The particles were about one third the number of particles in Sample 13B.

### EXAMPLE 20

As well as having greater solubility in water than their mother inulin from which they are produced, the sweetener powders of this invention surprisingly have greater solubility than sucrose in water at temperatures from 32° F. to 77° F., as demonstrated in the following tests.

0.395 grams of sucrose were put into a test tube with 7.9 grams of spring water at 77° F. [Sample 14S]. After the first gentle rocking, small suspended particles were visible. After continuous gentle rocking in a test tube for one minute, the sucrose crystals had decreased by about half. After an additional 35 seconds of rocking, the crystals were completely dissolved.

### EXAMPLE 21

0.398 grams of sucrose were put into a test tube with 7.970 grams of water at 50° F. [Sample 15S]. After gently inverting the test tube three times to get the sucrose into the water, the water was clear and the crystals of sucrose immediately settled in the bottom, covering the bottom. After 10 minutes there remained visible sugar crystals covering one quarter of the base of the test tube. After 3 hours at 50° F. there remained visible sugar crystals covering one eighth of the base of the test tube. After 6.5 hours at 50° F. there still remained visible sugar crystals covering one eighth of the base of the test tube. After 8.5 hours at 50° F. there still remained visible sugar crystals covering one eighth of the base of the test tube.

### EXAMPLE 22

0.355 grams of spray-dried low molecular weight inulin-sucralose powder of EXAMPLE 11 were put into a test tube with 7.890 grams of water at 50° F. [Sample 15A]. After gently inverting the test tube two times to get the inulin-sucralose powder into solution, the water was clear and the powder immediately went into solution. Transparent filaments of the powder were observed and lasted about 20 seconds and then disappeared.

### EXAMPLE 23

0.440 grams of sucrose were put into a test tube with 8.850 grams of water at 36° F. [Sample 16S]. After gently inverting the test tube three times to get the sucrose into the water, the water was clear and the crystals of sucrose immediately settled in the bottom, covering the bottom. After 30 minutes the sucrose crystals covered half the bottom while temperature of the solution rose to 40° F.

### EXAMPLE 24

0.410 grams of spray-dried low molecular weight inulin-sucralose powder of EXAMPLE 11 were put into a test tube with 8.200 grams of water at 36° F. [Sample 16A]. After gently inverting the test tube two times to get the inulin-sucralose powder into solution, the water was clear and the powder immediately went into solution. Transparent filaments of the powder were observed and lasted about 20 seconds and then disappeared.

### EXAMPLE 25

Spray-dried low molecular weight inulin-sucralose powder (of EXAMPLE 11) goes into solution instantaneously in cold drinks such as iced tea whereas sucrose, without stirring, does not. The sweetener powders of the invention have greater solubility in water and water base liquids at temperatures from about 36° F. to about 70° F. than sucrose.

### EXAMPLE 26

It was observed that the spray-dried low and high molecular weight inulin was about twice as soluble in distilled water at ambient temperatures than the mother inulin, but after 12 hours, was cloudy and contained some undissolved particles. It was further observed that the combination of low and high molecular weight inulin with sucralose was entirely soluble in distilled water at ambient temperatures, as compared to the spray-dried low and high molecular weight inulin without sucralose, and, after 12 hours was substantially entirely clear. The foregoing observation indicates a synergy for solubility in water by reason of the combination of powder inulin with sucralose.

### Other Ingredients

Other ingredients may be added to the powder before or after spray-drying, such as natural sweeteners, non-fat dry milk, lactose, polyols, extracts, flavorings, and the like.

The foregoing examples and tests are provided by way of explanation and illustration, and are not intended to limit the invention as defined by the scope of the appended claims. Variations in the manner of making and using the powders of the invention will be obvious to persons of ordinary skill in the art without departing from the scope of the following claims.

1. Soft, fluffy powders:
said powders containing inulin in amounts sufficient so that the inulin is at least the majority ingredient or the sole constituent;
said inulin powders comprising at least a major amount of substantially small particles; and
said small particles being in size about 30 micrometers or less across their largest dimension.

2. The powders of claim 1 containing low molecular weight inulin.

3. The powders of claim 1 containing high molecular weight inulin.

4. The powders of claim 1 containing high and low molecular weight inulin.

5. The powders of claim 1 in which at least about 75% of said particles are in their largest dimension less than about 30 micrometers.

6. The powders of claim 1 in which at least a majority of said particles have as their dimension less than about 20 micrometers.

7. The powders of claim 1 further characterized by unique tastes, mouth feel, and sweetness when compared to the mother inulin.

8. The powders of claim 1 in which said powders are more quickly soluble in water at ambient temperatures than corresponding non-powders of inulin.

9. The powders of claim 1 further characterized by being soluble in water in less than 5 seconds without stirring at ambient temperatures, and below.

10. The powders of claim 1 further characterized by lower hygroscopicity than powdered sucrose.

11. The powders of claim 1 in which said powders further contain sucralose intimately mixed with the inulin.

12. Soft, fluffy non-crystalline powder sweeteners comprising:
an intimate combination of inulin and sucralose having a sweet taste;
at least a majority of said combination of inulin and sucralose comprising small particles;
said small particles having as their largest size about 30 micrometers or less across their largest dimension;
said combination of inulin and sucralose in said powder having a weight ratio of inulin to sucralose in the range from about 1200:1 to about 1:1 on a dry weight basis;
said powder sweetener combination of inulin and sucralose having a greater solubility in water at ambient and lower temperatures than the mother inulin.

13. The powder sweeteners of claim 12 in which at least about 75% by volume of said particles are in their largest dimension less than about 30 micrometers.

14. The powder sweeteners of claim 12 in which at least a majority of said particles are in their largest dimension less than about 20 micrometers.

15. The powder sweeteners of claim 12 in which the ratio of inulin to sucralose is from about 900:1 to about 1:1 on a dry weight basis.

16. The powder sweeteners of claim 12 in which the ratio of inulin to sucralose is from about 700:1 to about 1:1 on a dry weight basis.

17. The powder sweeteners of claim 12 in which the ratio of inulin to sucralose is from about 500:1 to about 1:1 on a dry weight basis.

18. Soft, fluffy powder sweeteners comprising:
an intimate combination of inulin with at least one high intensity sweetener;
at least a majority of said combination of inulin with high intensity sweetener of said powder sweetener comprising small particles;
said powder sweeteners characterized by more rapid solubility in water than the mother inulin at ambient temperatures and below, and a lower hygroscopicity than powdered sucrose.

19. The powder sweetener of claim 18 in which said high intensity sweetener comprises acesulfame potassium.

20. The powder sweetener of claim 18 in which said high intensity sweetener comprises aspartame.

21. The powder sweetener of claim 18 further comprising at least one polyol.

22. The powder sweetener of claim 18 further comprising erythritol.

23. The powder sweetener of claim 18 further comprising xylitol.
